(19) United States
(12) Patent Application Publication
(10) Pub. No.: US 2017/0345405 A1
(43) Pub. Date: Nov. 30, 2017

(54) TEMPERATURE RISE CONTROLLABLE ANECHOIC SOUND ABSORBER USING TWO DIFFERENT KINDS OF SCATTERING PARTICLE AND METHOD FOR MANUFACTURING THE SAME

(71) Applicant: KOREA RESEARCH INSTITUTE OF STANDARDS AND SCIENCE, Daejeon (KR)

(72) Inventors: Yong Tae Kim, Daejeon (KR); Bong Young AHN, Daejeon (KR)

(73) Assignee: KOREA RESEARCH INSTITUTE OF STANDARDS AND SCIENCE, Daejeon (KR)

(21) Appl. No.: 15/263,043

(22) Filed: Sep. 12, 2016

(30) Foreign Application Priority Data
May 27, 2016 (KR) 10-2016-0065350

(51) Int. Cl. G10K 11/162

(52) U.S. Cl. CPC G10K 11/162

(57) ABSTRACT

The present disclosure relates to a temperature controllable anechoic sound absorber using two different kinds of scattering particles and a method for manufacturing the same. More specifically, a temperature rise controllable anechoic sound absorber using two different kinds of scattering particles, which absorbs a sound wave which is transmitted through a medium, includes a composite material which induces a scattering process of the sound wave and has a first scattering particle and a second scattering particle; and a base material which fills a base of the absorber during the scattering process of the sound wave. Herein, volume content ratios of the base material, the first scattering particle, and the second scattering particles are adjusted so that a heat capacity of the absorber is within a set heat capacity range.

### CROSS-REFERENCE TO RELATED APPLICATIONS

This application claims the priority of Korean Patent Application No. 2016-0065350 filed on May 27, 2016, in the Korean Intellectual Property Office, the disclosure of which is incorporated herein by reference.

### BACKGROUND

### Field

The present disclosure relates to a temperature controllable anechoic sound absorber using two different kinds of scattering particles and a method for manufacturing the same.

### Description of the Related Art

A sound absorber refers to a material having an excellent property of absorbing a sound wave. Some sound absorber uses outer porous material such as a texture, felt, or fabric and the other sound absorber uses resonance absorbance of a panel (a sound absorbing panel).

A sound absorber such as linen, cotton, asbestos, or rock wool may be used for a ceiling, a wall, or a floor of an indoor space. Further, the sound absorber may be used to mix cork particles, vermiculite, rock wool, sawdust, or pulp using cement, plaster, lime, or a paint as an adhesive agent.

Further, the absorber may also be used as an ultrasonic absorber which absorbs an ultrasonic wave.

Here, the ultrasonic wave refers to a wave which propagates a medium while vibrating the medium in an arbitrary direction at a frequency of 20 kHz or higher. The ultrasonic wave may concentrate energy at an acute angle to transmit the energy to a predetermined direction. When the media are different, the ultrasonic wave is reflected and refracted similarly to light.

Specifically, among ultrasonic absorbers, an ultrasonic anechoic sound absorber is utilized as a target for measurement of a radiation force scale, an underwater ultrasonic anechoic material, or a back sheet of an ultrasonic oscillator.

When the ultrasonic absorber is used for the back sheet of the ultrasonic oscillator, the ultrasonic absorber is attached on a rear surface of a piezoelectric material at the time of ultrasonic oscillation, to lower a Q value. Further, a broad band ultrasonic oscillator may be obtained. When the back sheet is not applied, interference occurs due to backside reflection during the ultrasonic oscillation, which results in resonance by a stationary wave.

A size of a scattering particle in an ultrasonic absorber needs to satisfy a Rayleigh scattering condition. In the Rayleigh scattering, as a content of the scattering particle is increased, a sound absorbing coefficient is increased. However, when the content of the scattering particle is too high, the strength of the absorber is weakened.

In order to solve the above-mentioned problem, Korean Registered Patent No. 1399491 which is filed and registered by the present inventor discloses an absorber configured by a composite material having a first scattering particle and a second scattering particle and a base material which fills a base of the absorber. A density of the first scattering particle which configures the absorber is higher than a density of the base material and a density of the second scattering particle is lower than the density of the base material, so that a desired level of reflectance and insertion loss may be achieved.

However, in the related art, an object to control a temperature rise amount in accordance with absorption of the sound wave is not disclosed.

A rubber material is mainly used for the base material which configures the absorber and the rubber material may be damaged due to heat at a predetermined temperature or higher.

In the related art, the temperature rise due to absorption of the sound and a damage of the base material thereby are not considered.

Therefore, an absorber which is capable of controlling a temperature rise amount due to sound absorption by considering at least one of a heat capacity and a thermal conductivity and a method for manufacturing and designing the absorber are demanded.

### RELATED ART DOCUMENT

### [Patent Document]

(Patent Document 1) Korean Registered Patent No. 1399491

### SUMMARY

The present invention has been made in an effort to provide an absorber which is not damaged by a high intensity of sound wave by increasing a heat capacity and a thermal conductivity of a three-phase composite material to which two different kinds of scattering particles are added for anechoic sound absorption to a desired level to reduce a thermal damage of a base material due to sound absorption and a method for manufacturing the same.

Further, according to the exemplary embodiment of the present invention, the heat capacity and the thermal conductivity are adjusted to design an absorber suitable for the purpose.

According to an exemplary embodiment of the present invention, an absorber and a method of manufacturing the same having the following advantages may be provided: A temperature rise amount by the absorption of a sound may be controlled in consideration of a heat capacity and thermal conduction and the absorber may be designed and manufactured to increase the temperature to a desired level. Further, a thermal equilibrium speed may be adjusted in accordance with an ambient temperature, temperature rise by the sound absorption may be adjusted, and the temperature rise below a temperature at which the base material is damaged is selected. Therefore, the loss by the high intensity of sound wave may be suppressed.

Other technical objects to be achieved in the present disclosure are not limited to the aforementioned technical objects, and other not-mentioned technical objects will be obviously understood by those skilled in the art from the description below.

According to a first aspect of the present invention, there is provided a temperature rise controllable anechoic sound absorber using two different kinds of scattering particles, which absorbs a sound wave which is transmitted through a medium. The absorber includes: a composite material which induces a scattering process of the sound wave and has a first scattering particle and a second scattering particle; and a base material which fills a base of the absorber during the scattering process of the sound wave. Herein, volume content ratios of the base material, the first scattering particle, and the second scattering particles may be adjusted so that a heat capacity of the absorber is within a set heat capacity range.

According to Equations 1, 2, and 3, the base material, the first scattering particle, and the second scattering particle having predetermined specific heats are selected and the densities and the volume content ratios are determined so that the absorber has a set heat capacity range.

$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ]\end{matrix}$$

In Equations 1, 2, and 3, Cis a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

According to a second aspect of the present invention, there is provided a method for manufacturing a temperature rise controllable anechoic sound absorber using two different kinds of scattering particles, which absorbs a sound wave which is transmitted through a medium. The method includes: determining a desired heat capacity range of the absorber to be manufactured; selecting materials in consideration of specific heats of a first scattering particle and a second scattering particle which configure a composite material inducing a scattering process of the sound wave and a base material which fills a base of the absorber during the scattering process of the sound wave; determining densities and volume content ratios of the first scattering particle, the second scattering particle, and the base material so that the absorber to be manufactured has the heat capacity range; and mixing and agitating the first scattering particle, the second scattering particle, and the base material at the volume content ratio.

In the determining of the desired heat capacity range, the heat capacity range may be determined based on at least one of an ambient temperature, a temperature rise rate, a maximum temperature value, a base material damaged temperature, and an intensity of the sound wave.

In the selecting of materials and determining of the volume content ratio, according to Equations 1, 2, and 3, the base material, the first scattering particle, and the second scattering particle having predetermined specific heats may be selected and the densities and the volume content ratios are determined so that the absorber has a set heat capacity range.

$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ]\end{matrix}$$

In Equations i, 2, and 3, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

According to a third aspect of the present invention, there is provided a temperature rise controllable anechoic sound absorber using two different kinds of scattering particles, which absorbs a sound wave which is transmitted through a medium. The absorber includes a composite material which induces a scattering process of the sound wave and has a first scattering particle and a second scattering particle; and a base material which fills a base of the absorber during the scattering process of the sound wave. Herein, volume content ratios of the base material, the first scattering particle, and the second scattering particles are adjusted so that a thermal conductivity of the absorber is within a set thermal conductivity range.

According to Equation 4, the base material, the first scattering particle, and the second scattering particle having a specific thermal conductivity may be selected and the volume content ratios may be determined so that the absorber has a set thermal conductivity range.

κ=κ₀Γ₀+κ₁Γ₁+κ₂Γ₂ [Equation 4]

In Equation 4, κ is a thermal conductivity of the absorber, κ₀ is a thermal conductivity of the base material, κ₁ is a thermal conductivity of the first scattering particle, κ₂ is a thermal conductivity of the second scattering particle, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

According to a fourth aspect of the present invention, there is provided a method for manufacturing a temperature rise controllable anechoic sound absorber using two different kinds of scattering particles, which absorbs a sound wave which is transmitted through a medium. The method includes: determining a desired thermal conductivity range of the absorber to be manufactured; selecting materials in consideration of thermal conductivities of a first scattering particle and a second scattering particle which configure a composite material inducing a scattering process of the sound wave and a base material which fills a base of the absorber during the scattering process of the sound wave; determining volume content ratios of the first scattering particle, the second scattering particle, and the base material so that the absorber to be manufactured has the thermal conductivity range; and mixing and agitating the first scattering particle, the second scattering particle, and the base material at the volume content ratio.

In the determining of the desired thermal conductivity range, the heat capacity range may be determined based on at least one of an ambient temperature, a temperature rise rate, a maximum temperature value, a base material damaged temperature, and an intensity of the sound wave.

In the selecting of materials and determining of the volume content ratio, according to Equation 4, the base material, the first scattering particle, and the second scattering particle having a specific thermal conductivity may be selected and the volume content ratios may be determined so that the absorber has a set thermal conductivity range.

κ=κ₀Γ₀+κ₁Γ₁+κ₂Γ₂ [Equation 4]

In Equation 4, κ is a thermal conductivity of the absorber, κ₀ is a thermal conductivity of the base material, κ₁ is a thermal conductivity of the first scattering particle, κ₂ is a thermal conductivity of the second scattering particle, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

According to a fifth aspect of the present invention, there is provided a temperature rise controllable anechoic sound absorber using two different kinds of scattering particles, which absorbs a sound wave which is transmitted through a medium. The absorber includes a composite material which induces a scattering process of the sound wave and has a first scattering particle and a second scattering particle; and a base material which fills a base of the absorber during the scattering process of the sound wave. Herein, volume content ratios of the base material, the first scattering particle, and the second scattering particles are adjusted so that a thermal diffusivity of the absorber is within a set thermal diffusivity range.

The heat capacity range and the thermal conductivity range of the absorber may be determined by the following Equation 5 so that the absorber is within a set thermal diffusivity range.

$$h = \frac{κ}{ρ {c}_{p}} \qquad [ Equation 5 ]$$

In Equation 5, h is a thermal diffusivity of the absorber, κ is a thermal conductivity of the absorber, ρ is a density of the absorber, and cₚ is a specific heat of the absorber.

Further, a base material, a first scattering particle, and a second scattering particle having predetermined specific heats and specific thermal conductivities may be selected and densities and volume content ratios are determined so that the absorber has a determined heat capacity range by the following Equations 1, 2, and 3 and has a determined thermal conductivity range by the following Equation 4.

$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ] \\ κ = {κ}_{0} {Γ}_{0} + {κ}_{1} {Γ}_{1} + {κ}_{2} {Γ}_{2} & [ Equation 4 ]\end{matrix}$$

In Equations 1, 2, 3, and 4, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V, and κ is a thermal conductivity of the absorber, κ₀ is a thermal conductivity of the base material, κ₁ is a thermal conductivity of the first scattering particle, and κ₂ is a thermal conductivity of the second scattering particle.

According to a sixth aspect of the present invention, there is provided a method for manufacturing a temperature rise controllable anechoic sound absorber using two different kinds of scattering particles, which absorbs a sound wave which is transmitted through a medium. The method includes: determining a desired thermal diffusivity range of the absorber to be manufactured; determining a heat capacity range and a thermal conductivity range of the absorber so that the absorber has the thermal diffusivity range; selecting materials in consideration of specific heats and thermal conductivities of a first scattering particle and a second scattering particle which configure a composite material inducing a scattering process of the sound wave and a base material which fills a base of the absorber during the scattering process of the sound wave; determining densities and volume content ratios of the first scattering particle, the second scattering particle, and the base material so that the absorber to be manufactured has the heat capacity range and the thermal conductivity range; and mixing and agitating the first scattering particle, the second scattering particle, and the base material at the volume content ratio.

In the determining of the desired thermal diffusivity range, the thermal diffusivity range may be determined based on at least one of an ambient temperature, a temperature rise rate, a maximum temperature value, a base material damaged temperature, and an intensity of the sound wave.

In the determining of the heat capacity range and the thermal conductivity range, the heat capacity range and the thermal conductivity range may be determined by the following Equation 5.

$$h = \frac{κ}{ρ {c}_{p}} \qquad [ Equation 5 ]$$

In Equation 5, h is a thermal diffusivity of the absorber, K is a thermal conductivity of the absorber, ρ is a density of the absorber, and cₚ is a specific heat of the absorber.

In the selecting of materials and determining of the volume content ratio, a base material, a first scattering particle, and a second scattering particle having specific heats may be selected and densities and volume content ratios are determined so that the absorber has a determined heat capacity range by the following Equations 1, 2, and 3 and has a determined thermal conductivity range by the following Equation 4.

$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ] \\ κ = {κ}_{0} {Γ}_{0} + {κ}_{1} {Γ}_{1} + {κ}_{2} {Γ}_{2} & [ Equation 4 ]\end{matrix}$$

In Equations 1, 2, 3, and 4, C, is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V, and κ is a thermal conductivity of the absorber, κ₀ is a thermal conductivity of the base material, κ₁ is a thermal conductivity of the first scattering particle, and κ₂ is a thermal conductivity of the second scattering particle.

According to an exemplary embodiment of the present invention, a heat capacity and a thermal conductivity of a three-phase composite material to which two different kinds of scattering particles for anechoic absorption are added are increased to a desired level, so that thermal damage of the base material due to the sound absorption is reduced. Therefore, the absorber is not damaged by a high intensity of sound wave.

Further, according to an exemplary embodiment of the present invention, the heat capacity and the thermal conductivity are adjusted to design an absorber suitable for a purpose.

According to an exemplary embodiment of the present invention, a temperature rise amount by the absorption of a sound is controlled in consideration of heat capacity and thermal conduction and the absorber may be designed and manufactured to increase the temperature to a desired level. Further, a thermal equilibrium speed may be adjusted in accordance with an ambient temperature, temperature rise may be adjusted by the sound absorption, and the temperature rise below a temperature at which the base material is damaged is selected. Therefore, the damage by the high intensity sound wave may be suppressed.

The effects to be achieved by the present disclosure are not limited to aforementioned effects and other effects, which are not mentioned above, will be apparently understood by those skilled in the art from the following description.

### BRIEF DESCRIPTION OF THE DRAWINGS

The accompanying drawings in the specification illustrate an exemplary embodiment of the present disclosure. The technical spirit of the present disclosure will be more clearly understood from the following detailed description taken in conjunction with the accompanying drawings. Therefore, the present invention will not be interpreted to be limited to the drawings:

FIG. 1 is a flowchart of a method for manufacturing a temperature rise controllable anechoic sound absorber using two different kinds of scattering particles according to a first exemplary embodiment of the present invention;

FIG. 2 is a graph of a specific heat of an absorber in accordance with a volume content ratio of a first scattering particle according to a first exemplary embodiment of the present invention;

FIG. 3 is a graph of a heat capacity per volume of an absorber in accordance with a volume content ratio of a first scattering particle according to a first exemplary embodiment of the present invention;

FIG. 4 is a flowchart of a method for manufacturing a temperature rise controllable anechoic sound absorber using two different kinds of scattering particles according to a second exemplary embodiment of the present invention;

FIG. 5 is a graph of a thermal conductivity of an absorber in accordance with a volume content ratio of a first scattering particle according to a second exemplary embodiment of the present invention;

FIG. 6 is a flowchart of a method for manufacturing a temperature rise controllable anechoic sound absorber using two different kinds of scattering particles according to a third exemplary embodiment of the present invention;

FIG. 7 is a graph of a temperature rise of an absorber in accordance with a time when a sound wave having intensities of 50 W, 100 W, 200 W, and 300 W is irradiated on an absorber formed of a PDMS material;

FIG. 8 is a graph of a temperature rise of 0 to 30 s of FIG. 6; and

FIG. 9 illustrates a graph of a temperature rise of an absorber in accordance with time (0 to 30 S) when a sound wave having intensities of 50 W, 100 W, 200 W, and 300 W is irradiated onto a temperature rise controllable anechoic sound absorber using two different kinds of scattering particles according to an exemplary embodiment of the present invention.

### DETAILED DESCRIPTION OF THE EMBODIMENT

The above and other objects, features and other advantages of the present disclosure will be more clearly understood from the following detailed description taken in conjunction with the accompanying drawings. As those skilled in the art would realize, the present disclosure is not limited to the described embodiments, but may be embodied in different ways. On the contrary, exemplary embodiments introduced herein are provided to make disclosed contents thorough and complete and sufficiently transfer the spirit of the present invention to those skilled in the art.

In this specification, when a component is referred to as being “on” another component, it may be directly on the other component, or intervening third component may be present. Further, in the drawings, the thicknesses of components are exaggerated for effectively describing the technical contents.

Exemplary embodiments described in this specification may be described with reference to cross-sectional views and/or plan views which are ideal exemplary views of the present disclosure. Further, in the drawings, the thicknesses of film and regions are exaggerated for effectively describing the technical contents. Therefore, a shape of the exemplary view may be modified by a manufacturing technology and/or an allowable error. Accordingly, exemplary embodiments of the present disclosure are not limited to specific illustrated types but may include modified types which are generated in accordance with the manufacturing process. For example, a region illustrated to have a right angle may be rounded or have a predetermined curvature. Therefore, regions illustrated in the drawings have properties. Shapes of the regions illustrated in the drawings are provided to illustrate a specific shape of a region of an element, but not limit the scope of the present disclosure. Although the terms “first”, “second”, and the like are used for describing various components, these components are not confined by these terms. These terms are merely used for distinguishing one component from the other components. Exemplary embodiments described herein include complementary embodiments thereof.

The terms used in the present specification are for explaining the embodiments rather than limiting the present invention. Unless particularly stated otherwise in the present specification, a singular form also includes a plural form. The term “comprises” and/or “comprising” used in this specification does not exclude the existence or addition of one or more other components.

When the following specific exemplary embodiments are described, various specific contents are provided for more specific description and understanding of the present disclosure. However, those skilled in the art may understand that the specific exemplary embodiment may be described without using the various specific contents. In some cases, a configuration which is generally known and does not directly relate to the present disclosure will be omitted in order to avoid confusion.

Hereinafter, a configuration of a temperature rise controllable anechoic absorber using two different kinds of scattering particles according to an exemplary embodiment of the present invention and a method for manufacturing the same will be described. The absorber according to an exemplary embodiment of the present invention absorbs a sound wave which is transmitted through a medium. The absorber induces a scattering process of the sound wave and is a three-phase material including a composite material having a first scattering particle and a second scattering particle and a base material which fills a base of the absorber during the scattering process of the sound wave.

According to an exemplary embodiment of the present invention, a heat capacity and a thermal conductivity of a three-phase composite material to which two different kinds of scattering particles for anechoic absorption are added are increased to a desired level, so that thermal damage of the base material due to the sound absorption is reduced. Therefore, the absorber is not damaged by a high intensity of sound wave. Further, the heat capacity and the thermal conductivity are adjusted to design an appropriate absorber. Further, in consideration of the heat capacity and the thermal conductivity, a temperature rise amount by the sound absorption is controlled and an absorber for increasing the temperature to a desired level may be designed and manufactured. The thermal equilibrium speed may be adjusted in accordance with the ambient temperature and the temperature rise due to sound absorption may be controlled. The temperature rise below a temperature at which the base material is damaged may be selected. As a result, the damage by a high intensity of sound wave may be suppressed.

Hereinafter, a method for designing and manufacturing an absorber according to first, second, and third exemplary embodiments of the present invention will be described.

### First Exemplary Embodiment

Hereinafter, a temperature rise controllable anechoic sound absorber using two different kinds of scattering particles according to a first exemplary embodiment of the present invention and a method for manufacturing the same will be described.

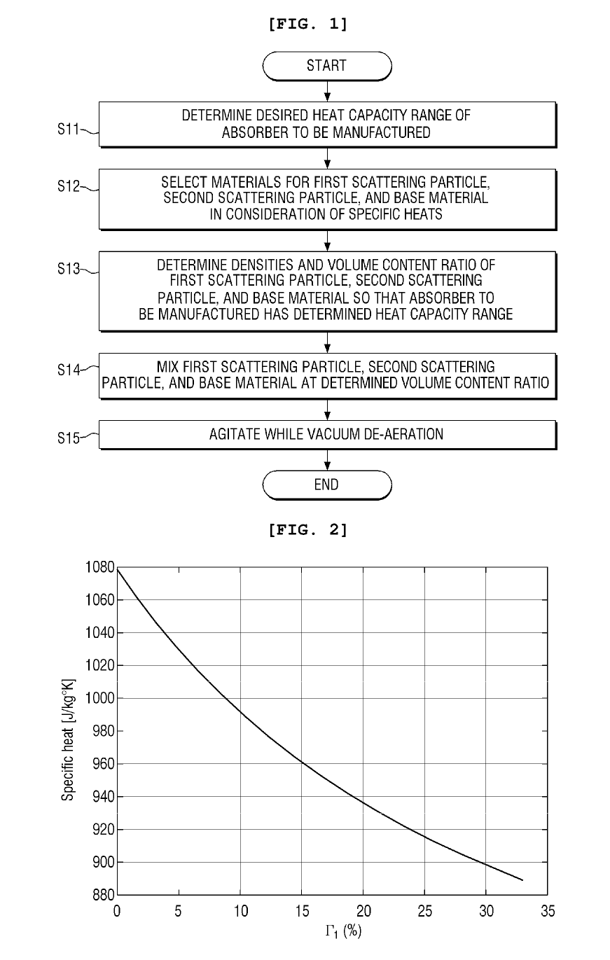

FIG. 1 is a flowchart of a method for manufacturing a temperature rise controllable anechoic sound absorber using two different kinds of scattering particles according to a first exemplary embodiment of the present invention. An absorber absorbs a sound wave which is transmitted through a medium and is configured by a composite material which induces a scattering process of the sound wave and a base material which fills a base of the absorber during the scattering process of the sound wave. The composite material according to the first exemplary embodiment of the present invention includes two different kinds of scattering particles, that is, a first scattering particle and a second scattering particle.

As the absorber according to the first exemplary embodiment of the present invention, at least one of the first scattering particle, the second scattering particle, and the base material each having a predetermined specific heat is selected and a volume content ratio is adjusted to manufacture and design an absorber having a desired heat capacity.

First, a desired heat capacity range of the absorber to be manufactured is determined in step S11. The heat capacity range is determined in consideration of an ambient temperature and an intensity of a sound wave to be transmitted. When a material for the base material has been determined, a heat capacity range which may satisfy the above conditions may be determined in consideration of a damaged temperature of the base material, a desired temperature rise rate of the absorber, and a maximum temperature value.

Materials are selected in consideration of specific heats of the base material, the first scattering particle, and the second scattering particle in step S12. Further, densities and volume content ratios of the first scattering particle, the second scattering particle, and the base material are determined and adjusted so that the absorber to be manufactured has a set and determined heat capacity range in step S13.

The materials for the base material, the first scattering particle, and the second scattering particle may be selected together. Otherwise, when at least one or two materials are fixed, the remaining material may be selected in consideration of a specific heat of the remaining material. The volume content ratio may also be considered.

The materials are selected and the densities and the volume content ratio are determined and selected to design the absorber with a desired heat capacity range, based on the following Equation 1, 2, and 3.

$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ]\end{matrix}$$

In Equations 1, 2, and 3, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, Cₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle.

Further, V=V₀+V₁+V₂ and Γ₀ is V₀/V, Γ₁ is V₁/V, and Γ₂ is V₂/V.

Therefore, according to Equations 1, 2, and 3, the base material, the first scattering particle, and the second scattering particle having predetermined specific heats are selected and the densities and the volume content ratios are determined so that the absorber has a set heat capacity range.

For example, when the materials of the base material, the first scattering particle, and the second scattering particle are selected and each specific heat is fixed, the volume content ratio of the base material is fixed to 67% so that the volume content ratio of the first scattering particle and the second scattering particle is 33%, the volume content ratio of the first scattering particle is adjusted to design the absorber to have a desired heat capacity range.

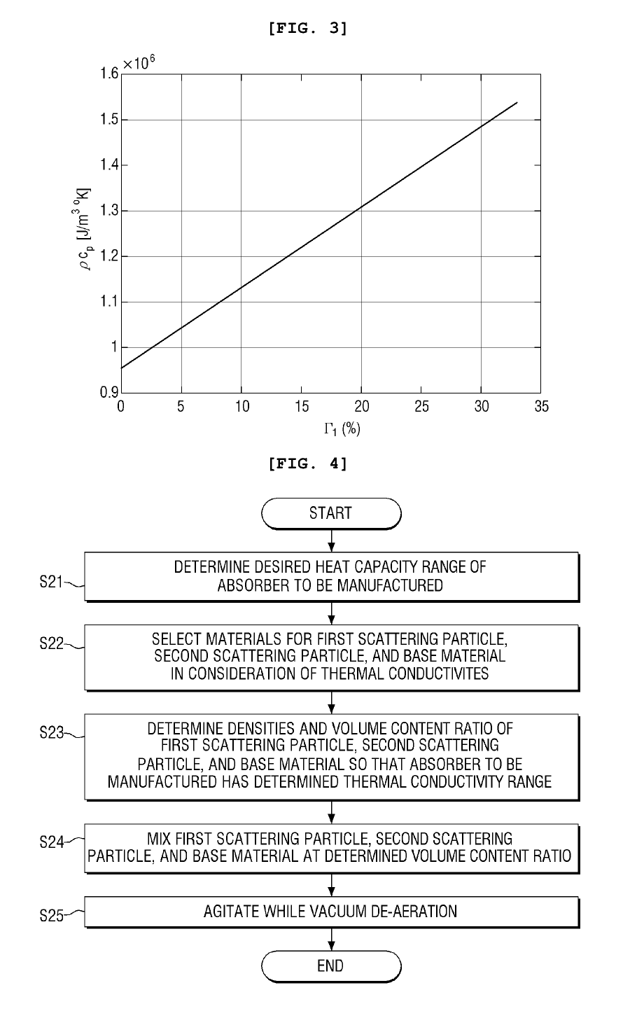

FIG. 2 illustrates a graph of a specific heat of an absorber in accordance with a volume content ratio of a first scattering particle according to a first exemplary embodiment of the present invention. FIG. 3 illustrates a graph of a heat capacity per volume of an absorber in accordance with a volume content ratio of a first scattering particle according to a first exemplary embodiment of the present invention. Here, the specific heat of the base material is 1100 J/kg·K, the specific heat of the first scattering particle is 750 J/kg·K, the specific heat of the second scattering particle is 1005 J/kg·K, the density of the base material is 1026 kg/m³, the density of the first scattering particle is 3160 kg/m³, and the density of the second scattering particle is 600 kg/m³. As illustrated in FIG. 3, it is understood that as the volume content ratio of the first scattering particle is increased, a heat capacity per unit volume of the absorber is increased.

The graph is created by the above-mentioned Equations 1, 2, and 3 and the volume content ratio of the first scattering particle is adjusted based on the graph so that the absorber may be designed to have a desired heat capacity range.

Further, the first scattering particle, the second scattering particle, and the base material are mixed at a volume content ratio which is determined to have a set heat capacity range in step S14 and the first scattering particle, the second scattering particle, and the base material are agitated while being vacuum de-aerated to manufacture an absorber in step S15.

### Second Exemplary Embodiment

Hereinafter, a temperature rise controllable anechoic sound absorber using two different kinds of scattering particles according to a second exemplary embodiment of the present invention and a method for manufacturing the same will be described.

FIG. 4 illustrates a flowchart of a method for manufacturing a temperature rise controllable anechoic sound absorber using two different kinds of scattering particles according to a second exemplary embodiment of the present invention.

The absorber absorbs a sound wave which is transmitted through a medium and is configured by a composite material which induces a scattering process of the sound wave and a base material which fills a base of the absorber during the scattering process of the sound wave. The composite material according to the second exemplary embodiment of the present invention includes two different kinds of scattering particles, that is, a first scattering particle and a second scattering particle.

As the absorber according to the second exemplary embodiment of the present invention, at least one of the first scattering particle, the second scattering particle, and the base material each having a specific thermal conductivity are selected and a volume content ratio is adjusted to manufacture and design an absorber having a desired thermal conductivity.

First, a desired thermal conductivity range of the absorber to be manufactured is determined in step S21. The thermal conductivity range is determined in consideration of an ambient temperature and an intensity of a sound wave to be transmitted. When a material for the base material has been determined, a damaged temperature of the base material, a desired temperature rise rate of the absorber, and a maximum temperature value are considered to determine a range of heat capacity which may satisfy the above conditions.

Materials are selected in consideration of thermal conductivities of the first scattering particle, the second scattering particle, and the base material, in step S22. A volume content ratio of the first scattering particle, the second scattering particle, and the base material is determined so that the absorber to be manufactured has a determined thermal conductivity range in step S23.

Therefore, in order to select the materials and determine the volume content ratio, according to Equation 4, the base material, the first scattering particle, and the second scattering particle having specific thermal conductivities are selected and the volume content ratios are determined so that the absorber has a set thermal conductivity range.

κ=κ₀Γ₀+κ₁Γ₁+κ₂Γ₂ [Equation 4]

In Equation 4, κ is a thermal conductivity of the absorber, κ₀ is a thermal conductivity of the base material, κ₁ is a thermal conductivity of the first scattering particle, κ₂ is a thermal conductivity of the second scattering particle, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle. Further, V=V₀+V₁+V₂ and Γ₀ is V₀/V, Γ₁ is V₁/V, and Γ₂ is V₂/V.

Therefore, according to Equation 4, the base material, the first scattering particle, and the second scattering particle having specific thermal conductivities are selected and the volume content ratios are determined so that the absorber has a set thermal conductivity range.

For example, when the materials of the base material, the first scattering particle, and the second scattering particle are selected and each thermal conductivity is fixed, the volume content ratio of the base material is fixed to 67% so that the volume content ratio of the first scattering particle and the second scattering particle is 33%, the volume content ratio of the first scattering particle is adjusted to design the absorber to have a desired thermal conductivity range.

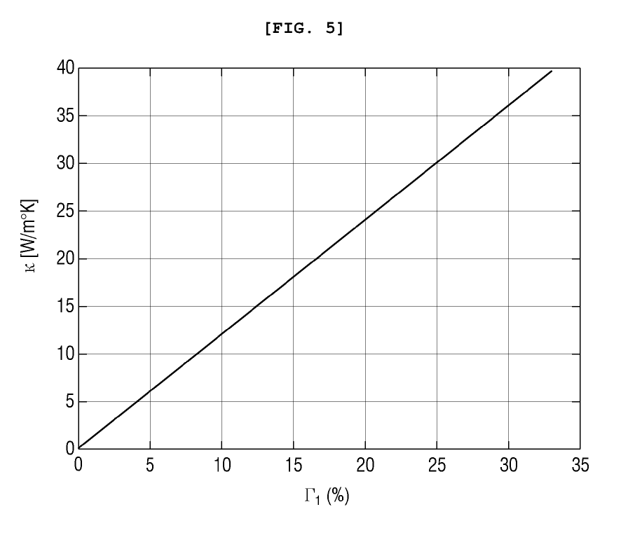

FIG. 5 illustrates a graph of a thermal conductivity of an absorber in accordance with a volume content ratio of a first scattering particle according to a second exemplary embodiment of the present invention. Here, a thermal conductivity of the base material is 0.18 W/m·K, a thermal conductivity of the first scattering particle is 120 W/m·K, and a thermal conductivity of the second scattering particle is 0.0267 W/m·K. As illustrated in FIG. 5, it is understood that as the volume content ratio of the first scattering particle is increased, a thermal conductivity of the absorber is increased.

The graph is created by the above-mentioned Equation 4 and the volume content ratio of the first scattering particle is adjusted based on the graph so that the absorber may be designed to have a desired thermal conductivity range.

Further, the first scattering particle, the second scattering particle, and the base material are mixed at a volume content ratio which is determined to have a set thermal conductivity range in step S24 and the first scattering particle, the second scattering particle, and the base material are agitated while being vacuum de-aerated to manufacture an absorber in step S25.

### Third Exemplary Embodiment

Hereinafter, a temperature rise controllable anechoic sound absorber using two different kinds of scattering particles according to a third exemplary embodiment of the present invention and a method for manufacturing the same will be described.

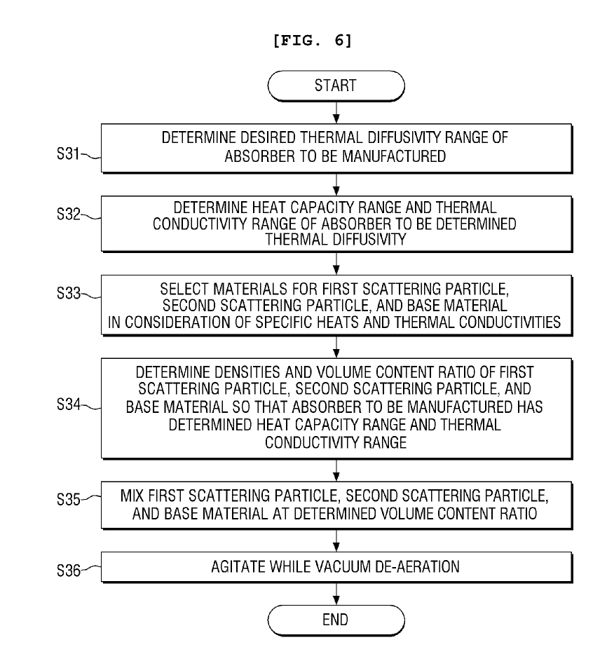

FIG. 6 illustrates a flowchart of a method for manufacturing a temperature rise controllable anechoic sound absorber using two different kinds of scattering particles according to a third exemplary embodiment of the present invention.

The absorber absorbs a sound wave which is transmitted through a medium and is configured by a composite material which induces a scattering process of the sound wave and a base material which fills a base of the absorber during the scattering process of the sound wave. The composite material according to the third exemplary embodiment of the present invention includes two different kinds of scattering particles, that is, a first scattering particle and a second scattering particle.

As the absorber according to the third exemplary embodiment of the present invention, at least one of the first scattering particle, the second scattering particle, and the base material each having a specific thermal conductivity and a predetermined specific heat is selected and a volume content ratio is adjusted to manufacture and design an absorber having a desired thermal diffusivity.

First, a desired thermal diffusivity range of the absorber to be manufactured is determined in step S31. The thermal diffusivity range is determined in consideration of an ambient temperature and an intensity of a sound wave to be transmitted. When a material for the base material has been determined, a damaged temperature of the base material, a desired temperature rise rate of the absorber, and a maximum temperature value are considered to determine a thermal diffusivity range which may satisfy the above conditions. That is, as the thermal diffusivity is increased, a temperature rise rate of the absorber which is increased when the sound wave is absorbed is lowered. As the thermal diffusivity is increased, a maximum temperature value which is increased by absorbing the sound wave is lowered. Therefore, a desired thermal diffusivity range of the absorber is determined in consideration of a desired temperature rise rate and the maximum temperature value.

Specifically, according to the following Equations 6, 7, and 8, required heat capacity and thermal diffusivity are determined so that the absorber has a maximum temperature, a temperature rise gradient, and a time constant at a set specific sound intensity.

$$\begin{matrix}Δ {T}_{max} = \frac{2 α I τ}{ρ {C}_{p}} & [ Equation 6 ] \\ \frac{dT}{{dt}_{0}} = \frac{Δ {T}_{max}}{τ} & [ Equation 7 ] \\ τ = \frac{0.03 λ}{h} & [ Equation 8 ]\end{matrix}$$

In Equations 6, 7, and 8, ΔTₘₐₓ is a maximum temperature rise amount, ρCₚ is a heat capacity of the absorber, α is an absorption coefficient of the absorber, I is an intensity of incident ultrasonic wave, τ is a time constant,

$$\frac{dT}{{dt}_{0}}$$

is an initial temperature rise gradient, and λ is a wavelength.

Further, the heat capacity range and the thermal conductivity range of the absorber may be determined so that the absorber to be manufactured has a set thermal diffusivity range in step S32. The heat capacity range and the thermal conductivity range are determined by the following Equation 5.

$$h = \frac{κ}{ρ {c}_{p}} \qquad [ Equation 5 ]$$

In Equation 5, h is a thermal diffusivity of the absorber, κ is a thermal conductivity of the absorber, ρ is a density of the absorber, and cₚ is a specific heat of the absorber. Therefore, ρcₚ corresponds to a heat capacity of the absorber per unit volume. Therefore, the heat capacity range and the thermal conductivity range of the absorber are determined based on Equation 5 so that the absorber has a set thermal diffusivity range.

Further, materials are selected in consideration of thermal conductivities of the first scattering particle, the second scattering particle, and the base material, in step S33. The densities and volume content ratios of the first scattering particle, the second scattering particle, and the bas material are determined so that the absorber to be manufactured has a determined heat capacity range and a determined thermal conductivity range to have a desired thermal diffusivity range in step S34.

In order to select the materials and determine the volume content ratio, the base material, the first scattering particle, the second scattering particle having specific heats and specific thermal conductivity are selected and the densities and the volume content ratios are determined so that the absorber has a determined heat capacity range by the above-mentioned Equations 1, 2, and 3 and the absorber has a determined thermal conductivity range by the above-mentioned Equation 4.

Further, the first scattering particle, the second scattering particle, and the base material are mixed at a volume content ratio which is determined to have a set thermal diffusivity range in step S35 and the first scattering particle, the second scattering particle, and the base material are agitated while being vacuum de-aerated to manufacture an absorber in step S36.

### [Comparison Data]

Hereinafter, temperature rises and maximum temperature values in accordance with sound wave absorption of an absorber configured by a single scattering particle and a temperature rise controllable anechoic sound absorber according to an exemplary embodiment of the present invention in which specific heats, thermal conductivities, and volume content ratios of two different kinds of scattering particles are adjusted are compared.

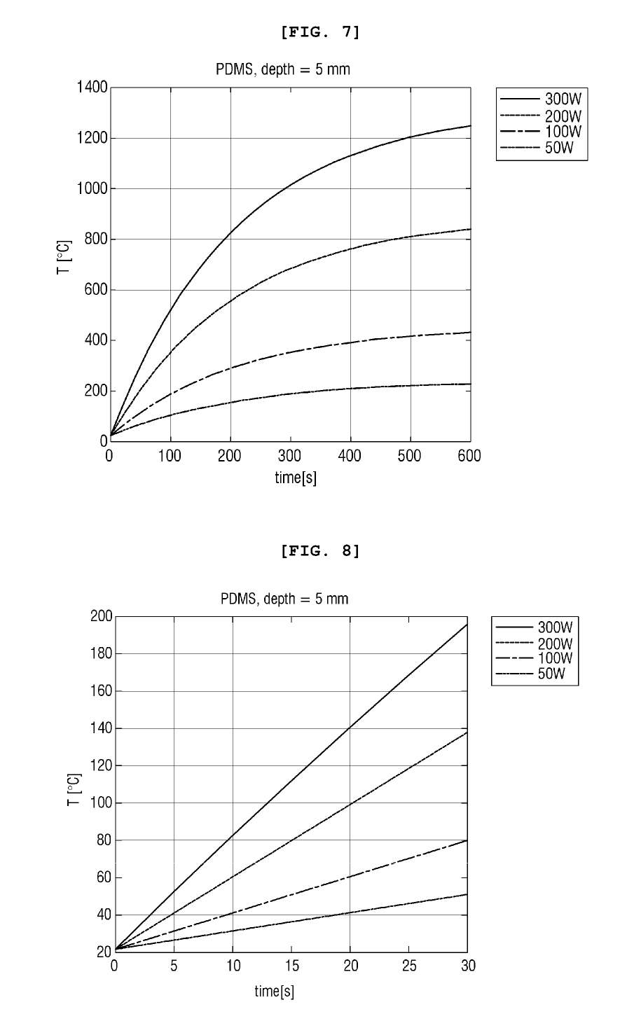

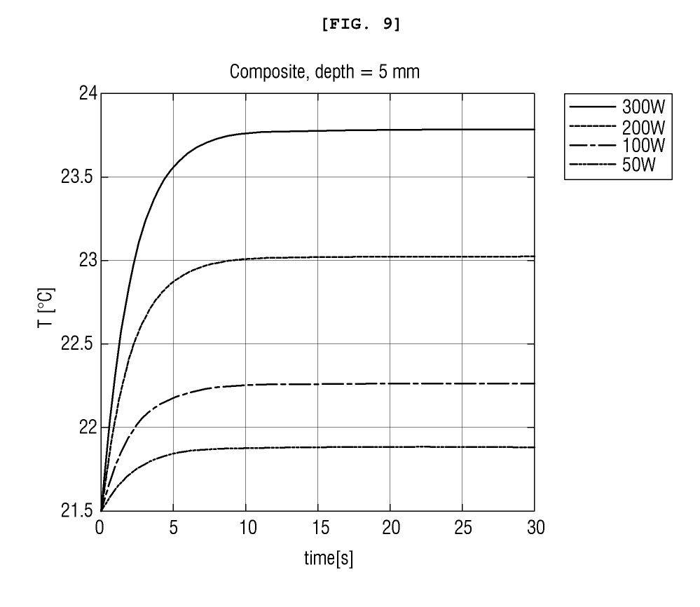

FIG. 7 illustrates a graph of a temperature rise of an absorber in accordance with a time when a sound wave having intensities of 50 W, 100 W, 200 W, and 300 W is irradiated on an absorber formed of a PDMS material. FIG. 8 illustrates a graph of a temperature rise of 0 to 30 s of FIG. 6.

FIG. 9 illustrates a graph of a temperature rise of an absorber in accordance with time (0 to 30 S) when a sound wave having intensities of 50 W, 100 W, 200 W, and 300 W is irradiated onto a temperature rise controllable anechoic sound absorber using two different kinds of scattering particles according to an exemplary embodiment of the present invention.

Specifically, FIG. 7 illustrates a temperature graph in accordance with a time when 300 W sound wave (ISA=1.53×10⁴ mW/cm²), 200 W sound wave (ISA=1.02×10⁴ mW/cm²), 100 W sound wave (ISA=5.09×10³ mW/cm²), and 50 W sound wave (ISA=2.55×10⁴ mW/cm²) are irradiated onto an absorber which is configured by a pure PDMS material.

A specific heat of the absorber configured by the pure PDMS material is 100 J/kg·K, a thermal conductivity is 0.18 W/m·K, and a thermal diffusivity is 1.595×10⁷ m²/s. As illustrated in FIG. 7, a time constant of the absorber configured by the pure PDMS material is 209 s. When 300 W sound wave is irradiated, the maximum temperature is 1325° C. When 200 W sound wave is irradiated, the maximum temperature is 890° C. When 100 W sound wave is irradiated, the maximum temperature is 456° C. When 50 W sound wave is irradiated, the maximum temperature is 239° C.

In contrast, FIG. 9 illustrates a graph of a temperature rise of an absorber in accordance with time (0 to 30 S) when a sound wave having an intensity of 50 W, 100 W, 200 W, and 300 W is irradiated onto a temperature rise controllable anechoic sound absorber using two different kinds of scattering particles according to an exemplary embodiment of the present invention. According to the first to third exemplary embodiments described above, the thermal diffusivity, the heat capacity, and the thermal conductivity of the absorber to be manufactured may be adjusted to satisfy the condition.

Specifically, 300 W sound wave (ISA=1.53×10⁴ mW/cm²), 200 W sound wave (ISA=1.02×10⁴ mW/cm²), 100 W sound wave (ISA=5.09×10³ mW/cm²), and 50 W sound wave (ISA=2.55×10⁴ mW/cm²) are irradiated onto an absorber having two different kinds of scattering particles and a base material according to an exemplary embodiment of the present invention with the same condition.

A specific heat of the absorber designed and manufactured according to the exemplary embodiment of the present invention is 905.8 J/kg·K, a thermal conductivity is 31.57 W/m·K, and a thermal diffusivity is 2.371×10⁵ m²/s. As illustrated in FIG. 9, a time constant of the absorber designed and manufactured according to the exemplary embodiment of the present invention is 2.165 s. When 300 W sound wave is irradiated, the maximum temperature is 23.8° C. When 200 W sound wave is irradiated, the maximum temperature is 23.0° C. When 100 W sound wave is irradiated, the maximum temperature is 22.3° C. When 50 W sound wave is irradiated, the maximum temperature is 21.9° C.

In the apparatus and the method thereof described above, the configuration and method of embodiments as described above may not be applied with limitation, but the embodiments may be configured by selectively combining all or a part of each embodiment such that various modifications may be made.

What is claimed is:

1. A temperature rise controllable anechoic sound absorber using two different kinds of scattering particles, which absorbs a sound wave which is transmitted through a medium, the absorber comprising:
a composite material which induces a scattering process of the sound wave and has a first scattering particle and a second scattering particle; and
a base material which fills a base of the absorber during the scattering process of the sound wave,
wherein volume content ratios of the base material, the first scattering particle, and the second scattering particles are adjusted so that a heat capacity of the absorber is within a set heat capacity range.

2. The absorber according to claim 1, wherein a base material, a first scattering particle, and a second scattering particle having specific heats are selected and densities and volume content ratios are determined by the following Equations 1, 2, and 3 so that the absorber has a set heat capacity range.
$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ]\end{matrix}$$
In Equations 1, 2, and 3, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

3. The absorber according to claim 2, wherein required heat capacity and thermal diffusivity are determined by the following Equations 6, 7, and 8, so that the absorber has a maximum temperature, a temperature rise gradient, and a time constant at a specific set sound intensity.
$$\begin{matrix}Δ {T}_{max} = \frac{2 α I τ}{ρ {C}_{p}} & [ Equation 6 ] \\ \frac{dT}{{dt}_{0}} = \frac{Δ {T}_{max}}{τ} & [ Equation 7 ] \\ τ = \frac{0.03 λ}{h} & [ Equation 8 ]\end{matrix}$$
In Equations 6, 7, and 8, ΔTₘₐₓ is a maximum temperature rise amount, ρCₚ is a heat capacity of the absorber, a is an absorption coefficient of the absorber, I is an intensity of incident ultrasonic wave, τ is a time constant,
$$\frac{dT}{{dt}_{0}}$$
is an initial temperature rise gradient, and λ is a wavelength.

4. A method for manufacturing a temperature rise controllable anechoic sound absorber using two different kinds of scattering particles, which absorbs a sound wave which is transmitted through a medium, the method comprising:
determining a desired heat capacity range of the absorber to be manufactured;
selecting materials in consideration of specific heats of a first scattering particle and a second scattering particle which configure a composite material inducing a scattering process of the sound wave and a base material which fills a base of the absorber during the scattering process of the sound wave;
determining densities and volume content ratios of the first scattering particle, the second scattering particle, and the base material so that the absorber to be manufactured has the heat capacity range; and
mixing and agitating the first scattering particle, the second scattering particle, and the base material at the volume content ratio.

5. The method according to claim 4, wherein in the determining of the desired heat capacity range, the heat capacity range is determined based on at least one of an ambient temperature, a temperature rise rate, a maximum temperature value, a base material damaged temperature, and an intensity of the sound wave.

6. The method according to claim 5, wherein in the selecting of materials and determining of the volume content ratio, a base material, a first scattering particle, and a second scattering particle having specific heats are selected and densities and volume content ratios are determined by the following Equations 1, 2, and 3 so that the absorber has a set heat capacity range.
$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ]\end{matrix}$$
In Equations 1, 2, and 3, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

7. A temperature rise controllable anechoic sound absorber using two different kinds of scattering particles, which absorbs a sound wave which is transmitted through a medium, the absorber comprising:
a composite material which induces a scattering process of the sound wave and has a first scattering particle and a second scattering particle; and
a base material which fills a base of the absorber during the scattering process of the sound wave,
wherein volume content ratios of the base material, the first scattering particle, and the second scattering particles are adjusted so that a thermal conductivity of the absorber is within a set thermal conductivity range.

8. The absorber according to claim 7, wherein a base material, a first scattering particle, and a second scattering particle having specific thermal conductivities are selected and volume content ratios are determined by the following Equation 4 so that the absorber has a set thermal conductivity range.
κ=κ₀Γ₀+κ₁Γ₁+κ₂Γ₂ [Equation 4]
In Equation 4, κ is a thermal conductivity of the absorber, κ₀ is a thermal conductivity of the base material, κ₁ is a thermal conductivity of the first scattering particle, κ₂ is a thermal conductivity of the second scattering particle, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

9. A method for manufacturing a temperature rise controllable anechoic sound absorber using two different kinds of scattering particles, which absorbs a sound wave which is transmitted through a medium, the method comprising:
determining a desired thermal conductivity range of the absorber to be manufactured;
selecting materials in consideration of thermal conductivities of a first scattering particle and a second scattering particle which configure a composite material inducing a scattering process of the sound wave, and a base material which fills a base of the absorber during the scattering process of the sound wave;
determining volume content ratios of the first scattering particle, the second scattering particle, and the base material so that the absorber to be manufactured has the thermal conductivity range; and
mixing and agitating the first scattering particle, the second scattering particle, and the base material at the volume content ratio.

10. The method according to claim 9, wherein in the determining of the desired thermal conductivity range, the thermal conductivity range is determined based on at least one of an ambient temperature, a temperature rise rate, a maximum temperature value, a base material damaged temperature, and an intensity of the sound wave.

11. The method according to claim 10, wherein in the selecting of materials and determining of the volume content ratio, a base material, a first scattering particle, and a second scattering particle having specific thermal conductivities are selected and volume content ratios are determined by the following Equation 4 so that the absorber has a set thermal conductivity range.
κ=κ₀Γ₀+κ₁Γ₁+κ₂Γ₂ [Equation 4]
In Equation 4, κ is a thermal conductivity of the absorber, κ₀ is a thermal conductivity of the base material, κ₁ is a thermal conductivity of the first scattering particle, κ₂ is a thermal conductivity of the second scattering particle, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V.

12. A temperature rise controllable anechoic sound absorber using two different kinds of scattering particles, which absorbs a sound wave which is transmitted through a medium, the absorber comprising:
a composite material which induces a scattering process of the sound wave and has a first scattering particle and a second scattering particle; and
a base material which fills a base of the absorber during the scattering process of the sound wave,
wherein volume content ratios of the base material, the first scattering particle, and the second scattering particles are adjusted so that a thermal diffusivity of the absorber is within a set thermal diffusivity range.

13. The absorber according to claim 12, wherein the heat capacity range and the thermal conductivity range of the absorber are determined by the following Equation 5 so that the absorber is within a set thermal diffusivity range.
$$h = \frac{κ}{ρ {c}_{p}} \qquad [ Equation 5 ]$$
In Equation 5, h is a thermal diffusivity of the absorber, κ is a thermal conductivity of the absorber, ρ is a density of the absorber, and cₚ is a specific heat of the absorber.

14. The absorber according to claim 13, wherein a base material, a first scattering particle, and a second scattering particle having specific heats and specific thermal conductivities are selected and densities and volume content ratios are determined so that the absorber has a determined heat capacity range by the following Equations 1, 2, and 3 and has a determined thermal conductivity range by the following Equation 4.
$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ] \\ κ = {κ}_{0} {Γ}_{0} + {κ}_{1} {Γ}_{1} + {κ}_{2} {Γ}_{2} & [ Equation 4 ]\end{matrix}$$
In Equations 1, 2, 3, and 4, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρCₚ is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V, and κ is a thermal conductivity of the absorber, κ₀ is a thermal conductivity of the base material, κ₁ is a thermal conductivity of the first scattering particle, and κ₂ is a thermal conductivity of the second scattering particle.

15. A method for manufacturing a temperature rise controllable anechoic sound absorber using two different kinds of scattering particles, which absorbs a sound wave which is transmitted through a medium, the method comprising:
determining a desired thermal diffusivity range of the absorber to be manufactured;
determining a heat capacity range and a thermal conductivity range of the absorber so that the absorber has the thermal diffusivity range;
selecting materials in consideration of specific heats and thermal conductivities of a first scattering particle and a second scattering particle which configure a composite material inducing a scattering process of the sound wave, and a base material which fills a base of the absorber during the scattering process of the sound wave;
determining densities and volume content ratios of the first scattering particle, the second scattering particle, and the base material so that the absorber to be manufactured has the heat capacity range and the thermal conductivity range; and
mixing and agitating the first scattering particle, the second scattering particle, and the base material at the volume content ratio.

16. The method according to claim 15, wherein in the determining of the desired thermal diffusivity range, the thermal diffusivity range is determined based on at least one of an ambient temperature, a temperature rise rate, a maximum temperature value, a base material damaged temperature, and an intensity of the sound wave.

17. The method according to claim 16, wherein in the determining of the heat capacity range and the thermal conductivity range, the heat capacity range and the thermal conductivity range are determined by the following Equation 5.
$$h = \frac{κ}{ρ {c}_{p}} \qquad [ Equation 5 ]$$
In Equation 5, h is a thermal diffusivity of the absorber, κ is a thermal conductivity of the absorber, ρ is a density of the absorber, and cₚ is a specific heat of the absorber.

18. The method according to claim 17, wherein in the selecting of materials and determining of the volume content ratio, a base material, a first scattering particle, and a second scattering particle having specific heats and specific thermal conductivities are selected and densities and volume content ratios are determined so that the absorber has a determined heat capacity range by the following Equations 1, 2, and 3 and has a determined thermal conductivity range by the following Equation 4.
$$\begin{matrix}{C}_{p} = {C}_{p 0} \frac{{ρ}_{0}}{ρ} {Γ}_{0} + {C}_{p 1} \frac{{ρ}_{1}}{ρ} {Γ}_{1} + {C}_{p 2} \frac{{ρ}_{2}}{ρ} {Γ}_{2} & [ Equation 1 ] \\ \frac{{c}_{p}}{V} = ρ {C}_{p} & [ Equation 2 ] \\ ρ = {ρ}_{0} {Γ}_{0} + {ρ}_{1} {Γ}_{1} + {ρ}_{2} {Γ}_{2} & [ Equation 3 ] \\ κ = {κ}_{0} {Γ}_{0} + {κ}_{1} {Γ}_{1} + {κ}_{2} {Γ}_{2} & [ Equation 4 ]\end{matrix}$$
In Equations 1, 2, 3, and 4, Cₚ is a specific heat of the absorber, Cₚ₀ is a specific heat of the base material, Cₚ₁ is a specific heat of the first scattering particle, Cₚ₂ is a specific heat of the second scattering particle, ρ is a density of the absorber, ρ₀ is a density of the base material, ρ₁ is a density of the first scattering particle, ρ₂ is a density of the second scattering particle, ρC_{ρ}is a heat capacity of the absorber, V is a volume of the absorber, V₀ is a volume of the base material, V₁ is a volume of the first scattering particle, V₂ is a volume of the second scattering particle, Γ₀ is a volume content ratio of the base material, Γ₁ is a volume content ratio of the first scattering particle, and Γ₂ is a volume content ratio of the second scattering particle, and V=V₀+V₁+V₂, and Γ₀ is V₀/V, Γ₁ is V₁/V, and Γ₂ is V₂/V, and κ is a thermal conductivity of the absorber, κ₀ is a thermal conductivity of the base material, κ₁ is a thermal conductivity of the first scattering particle, and κ₂ is a thermal conductivity of the second scattering particle.
